(19) United States
(12) Patent Application Publication
(10) Pub. No.: US 2025/0247659 A1
(43) Pub. Date: Jul. 31, 2025

(54) ELECTRONIC CONTROL DEVICE

(71) Applicant: DENSO CORPORATION, Kariya-city (JP)

(72) Inventors: TAKAHIRO HIRANO, Kariya-city (JP); SHIGEKI NAKAMURA, Kariya-city (JP)

(21) Appl. No.: 18/923,042

(22) Filed: Oct. 22, 2024

(30) Foreign Application Priority Data
Jan. 30, 2024 (JP) 2024-011881

(51) Int. Cl. H04R 29/00; B60W 50/14; B60W 60/00; H04R 3/00

(52) U.S. Cl. CPC H04R 29/001; B60W 50/14; H04R 3/00; B60W 60/0053; H04R 2499/13

(57) ABSTRACT

An electronic control device includes a controller, a sound output unit, and a sound input unit. The sound output unit electrically connects the controller to a speaker and the sound input unit electrically connects the controller to a microphone. The controller is configured to perform an operation check by outputting a sound pattern from the speaker through the sound output unit after converting the sound pattern into an inaudible pattern, and receiving the sound pattern from the microphone through the sound input unit. The sound pattern is at least one of sound patterns predetermined based on warning stages for a driver of a vehicle or vehicle models.

### CROSS REFERENCE TO RELATED APPLICATION

The present application claims the benefit of priority from Japanese Patent Application No. 2024-011881 filed on Jan. 30, 2024. The entire disclosure of the above application is incorporated herein by reference.

### TECHNICAL FIELD

The present disclosure relates to an electronic control device.

### BACKGROUND

When the vehicle performs autonomous driving, driving authority may be transferred from the system to the driver.

### SUMMARY

According to one aspect, the electronic control device includes a controller, a sound output unit, and a sound input unit. The sound output unit electrically connects the controller to a speaker. The sound input unit electrically connects the controller to a microphone. The controller is configured to perform an operation check by outputting a sound pattern from the speaker through the sound output unit after converting the sound pattern into an inaudible pattern, and by receiving the sound pattern from the microphone through the sound input unit. The sound pattern is at least one of sound patterns predetermined based on warning stages for a driver of a vehicle or vehicle models.

### BRIEF DESCRIPTION OF THE DRAWINGS

FIG. 1 is a diagram showing an electrical configuration of an electronic control device according to an embodiment; and

FIG. 2 is a flowchart schematically showing a processing operation.

### DETAILED DESCRIPTION OF THE PREFERRED EMBODIMENTS

To begin with, examples of relevant techniques will be described.

A vehicle includes many ECUs and the ECUs cooperatively work together to perform various controls in the vehicle. ECU is an abbreviation of Electronic Control Unit. In recent years, an integrated ECU that integrates various functions has been considered. Additionally, the vehicle is provided with an ADAS function. ADAS is an abbreviation for Advanced Driving Assistant System and refers to an advanced driving assistance system. When the vehicle performs autonomous driving with the ADAS function, if a malfunction or temporary suspension of the autonomous driving occurs, driving authority should be reliably transferred from the system to the driver. At this time, the system performs visual and/or audible warnings and guidance to instruct the driver to perform manual driving. In particular, audible warnings, which has high diffusivity, are important as a notification method.

Notification sounds and warning sounds for occupants have various types, ranging from minor to serious warnings. Additionally, notification sounds and warning sounds differ depending on vehicle models. For example, as described in the background, the driving authority may not be appropriately transferred if the warning sound is not reliably transmitted to the occupants. For this reason, a sound output check is recommended according to the type of warning or notification before actually emitting a notification sound or warning sound. However, repeatedly emitting test sound patterns may confuse or annoy the occupants.

The present disclosure has been made in view of the above circumstances, and the purpose of the present disclosure is to provide an electronic control device that enables sound output checks according to the type of warning or notification.

According to one aspect, the electronic control device includes a controller, a sound output unit, and a sound input unit. The sound output unit electrically connects the controller to a speaker. The sound input unit electrically connects the controller to a microphone. The controller is configured to perform an operation check by outputting a sound pattern from the speaker through the sound output unit after converting the sound pattern into an inaudible pattern, and by receiving the sound pattern from the microphone through the sound input unit. The sound pattern is at least one of sound patterns predetermined based on warning stages for a driver of a vehicle or vehicle models. The controller performs the operation check through the sound output unit and the sound input unit with the sound pattern which is predetermined based on the warning stages for the driver or the vehicle models and has converted into the inaudible pattern. Thus, sound output test according to the types of warning/notification can be easily performed. Further, the operation check with the inaudible pattern does not annoy the occupants.

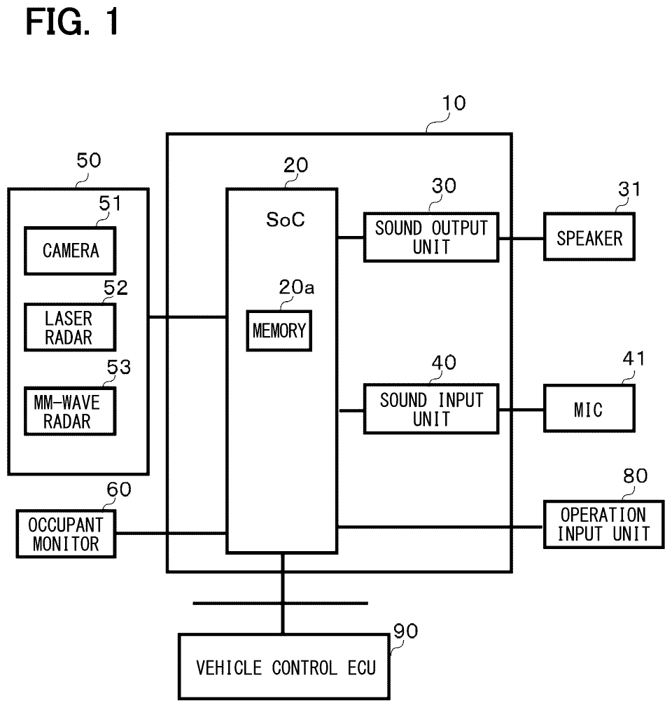

An embodiment of the electronic control device will be described below. FIG. 1 is a block diagram showing a configuration of an electronic control device 10. The electronic control device 10 constitutes an integrated ECU, which integrates an HMI function and an ADAS function. HMI is an abbreviation for Human Machine Interface, and indicates the function of executing operation input, image output, and sound input/output. ADAS is an abbreviation for Advanced Driving Assistant System, and indicates the functions of the advanced driving assistance system, including driving assistance functions such as warnings and driving controls. Examples of the driving assistance functions include automatic braking, lane keep assist, lane departure warning, and autonomous driving.

The electronic control device 10 is equipped with a SoC 20, a sound output unit 30, and a sound input unit 40. The SoC is an abbreviation for System On Chip. The SoC 20 corresponds to a controller of the present application. The SoC 20 is configured by integrating a microcontroller, a memory 20a, and the like. The memory 20a is a non-volatile/volatile memory and is configured as a non-transitory tangible recording medium. The memory 20a stores programs executed by the SoC 20, and the SoC 20 executes the programs to realize various functions. The memory 20a also stores sound patterns for operation check in a non-volatile manner. The sound patterns referred to here are patterns of notification sounds or warning sounds having volumes and frequency characteristics that are commonly available among vehicle models with the electronic control device 10, or a combined sound pattern that is a composite of the patterns. The sound patterns are stored as digital data in the memory 20a.

The sound output unit 30 is an interface circuit that electrically connects the SoC 20 to a speaker 31 installed in the vehicle. The sound output unit 30 includes a drive control circuit for the speaker 31. The sound input unit 40 is an interface circuit that electrically connects the SoC 20 to a microphone 41 installed in the vehicle. The sound input unit 40 includes a signal input circuit for the microphone 41 and a determination circuit.

The SoC 20 is connected to a surroundings monitoring system 50, an occupant monitor 60, and an operation input unit 80. In addition, the SoC 20 is connected to a vehicle control ECU 90 via an in-vehicle network. The surroundings monitoring system 50 is mainly composed of surrounding cameras 51 that capture images around the vehicle, such as a front view camera, a side view camera, a corner view camera, a back view camera, an electronic mirror, a laser radar 52 using LiDaR, and/or a millimeter wave radar 53. The surroundings monitoring system 50 monitors the situation around the vehicle and transmits the captured image information and monitoring information to the SoC 20.

The occupant monitor 60 monitors the status of the occupants in the vehicle using a driver status monitor (DSM) that captures an image of the driver with a camera and a passenger status monitor (PSM) that captures an image of the passenger in the front passenger seat with a camera and observes the status of the passenger. The occupant monitor 60 represents a high-performance recognition system that automatically recognizes the faces and bodies of the occupants in the vehicle, such as the driver, using a camera, and detects the driving status of the driver.

The SoC 20 is also connected to a display device (not shown) for displaying various types of information. The operation input unit 80 is, for example, a touch panel configured on the display screen of the display device or a mechanical switch provided beside the display screen, and receives operation input from the occupants such as the driver. For example, the operation switch includes a switch for switching between a manual driving mode, a driving assistance mode, and an autonomous driving mode. When the operation input unit 80 receives an operation input, the SoC 20 accepts the operation input and executes controls based on operation signals from the operation input unit 80.

The SoC 20 can realize various ADAS functions using the state of the surrounding environment acquired by the surroundings monitoring system 50 and the status of the occupants acquired by the occupant monitor 60. When the driving mode is switched to the manual driving mode, the electronic control device 10 communicates with the vehicle control ECU 90 connected to the in-vehicle network, and the vehicle control ECU 90 controls the driving actuators based on manual driving. When the driving mode is switched to the driving assistance mode or the autonomous driving mode, the electronic control device 10 communicates with the vehicle control ECU 90, and the vehicle control ECU 90 controls the driving actuators (not shown) to provide specified driving assistance or autonomous driving according to the autonomous driving level.

The following describes the notification sound and warning sound emitted to alert the occupants in the vehicle. In recent years, the occupant in the vehicle have been able to drive vehicles manually, with driving assistance, or autonomously. For example, if the in-vehicle system automatically switches the driving mode from the autonomous driving mode to the manual driving mode due to some kind of effect, the in-vehicle system will alert the driver by displaying a warning on the display device or emitting a warning sound. Conventionally, the display device is used to display the route to a target destination, and audio notification is used to inform the driver of the driving direction as a vehicle navigation function for guiding the driver to a target direction or a destination. In particular, “audio”, which has high diffusivity, is an important means of transmitting information as this type of notification or warning method.

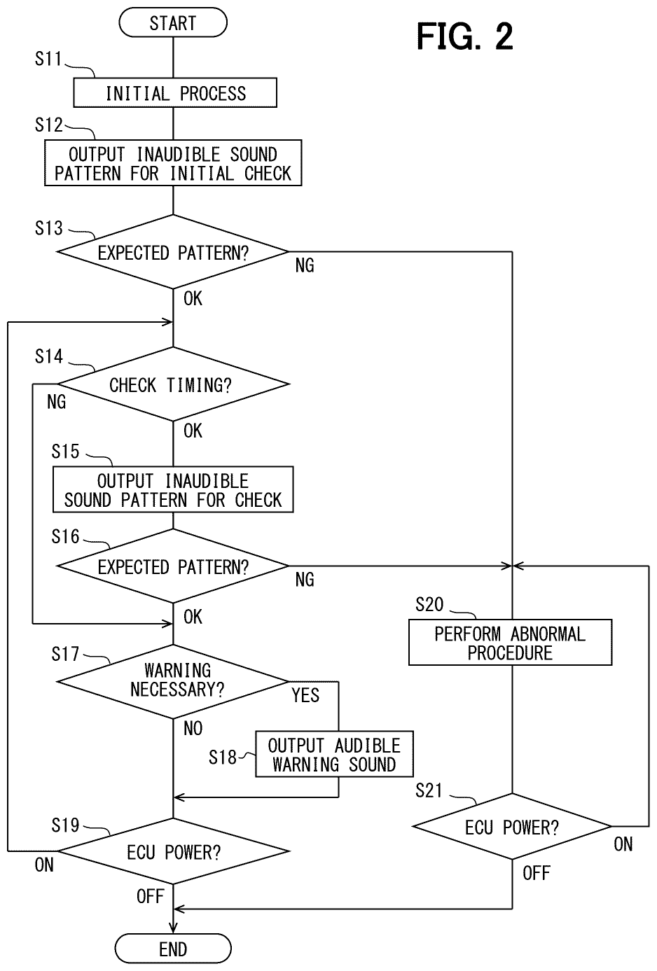

For example, as mentioned above, when the driving mode is switched from the autonomous driving to the manual driving, if the occupants cannot recognize a sound from the speaker 31 through the sound output unit 30, the ADAS function will not reliably transfer the driving authority to the driver. For this reason, it is important to diagnose whether sound notification is reliably emitted to the occupants before actually emitting a warning sound or similar alert to the occupants. Thus, in this embodiment, output check of a notification sound or warning sound is performed as shown in FIG. 2.

The process shown in FIG. 2 is executed immediately after the ignition switch is turned on and the vehicle is activated. When the ignition switch is turned on, power is supplied to the electronic control device 10. In S11, the SoC 20 executes an initial process (i.e., an initialization process) for the sound output unit 30 and the sound input unit 40. Immediately after activation of the SoC 20, the SoC 20 causes the sound output unit 30 to output from the speaker 31 an inaudible sound pattern for initial operation check. The inaudible sound pattern is then input into the SoC 20 from the microphone 41 through the sound input unit 40. The frequency of the inaudible sound referred to here is a high frequency that is generally inaudible to humans, and is preferably 20,000 Hz or higher, but may also be 10,000 Hz or higher, or a high frequency of several thousand Hz or higher. Conversely, the inaudible sound may be a low-frequency sound of about a few Hz, less than 20 Hz, which is defined as inaudible to humans.

When the SoC 20 performs an operation check for sound input and sound output, it is preferable to use a sound pattern having a certain level of complexity with varying frequency and volume. Also, it is preferable to check the consistency of the sound pattern received from the microphone 41 by pattern matching in accordance with the sound pattern. This can increase the reliability of the operation check.

The sound pattern of the audible notification sound or warning sound emitted while the vehicle performs normal driving or the vehicle stops varies depending on the warning stages for the driver or the vehicle models. For example, the audible sound pattern for a minor warning that warns veering out of the driving lane is a monotonous pattern at regular intervals such as “beep, beep, beep”, while the audible sound pattern for preventing a collision with an obstacle includes a higher frequency sound at shorter intervals to indicate a more serious warning.

Furthermore, the sound pattern of the warning sound differs depending on whether the vehicle is a luxury car or a mass-market car. Therefore, the inaudible sound pattern for the operation check in S12 preferably depends on the audible sound pattern of the warning sound. In this case, the relationship between the frequency range of inaudible sounds for the operation check and the frequency range of audible sounds is preferably predetermined.

For example, the inaudible sound pattern for warning may be prepared by adding predetermined frequency (for example, about several kHz to 10,000 Hz) to the frequency of the audible sound pattern for warning, and converting the obtained sound pattern to the inaudible sound pattern. The process can be simplified by simply adding the predetermined frequency to the sound pattern having audible frequencies. Here, an example where the inaudible sound patterns are prepared by simply adding the predetermined frequency to the audible sound patterns will be described. However, the present disclosure is not limited to this, and any relationship between the inaudible sound patterns and the audible sound patterns is acceptable as long as the inaudible sound patterns correlate with the audible sound patterns.

When the sound input unit 40 inputs an inaudible sound pattern through the microphone 41, the SoC 20 determines in S13 whether the inaudible sound pattern corresponds to an expected pattern. The SoC 20 compares the sound pattern stored in the memory 20a with the sound pattern input through the microphone 41. If the SoC 20 determines in S13 that the sound pattern input through the microphone 41 does not correspond to the expected pattern, the SoC 20 determines a malfunction with the sound output system of the sound output unit 30 and the speaker 31, or the sound input system of the sound input unit 40 and the microphone 41 (NG in S13), and performs abnormal situation procedure in S20. In the abnormal situation procedure, the SoC 20 constantly displays a warning regarding the sound output/input to the driver on the display device or the like, thereby instructing the driver to have the vehicle repaired by a dealer or the like. At this time, the SoC 20 restricts the function of outputting notification sounds and warning sounds in S20, and maintains the restriction on the function until the power of the electronic control device 10 is turned off in S21. Furthermore, if the SoC 20 determines in S13 that the sound pattern corresponds to the expected pattern (OK in S13), the SoC 20 determines that the operation check at the activation has been successfully cleared.

After the vehicle is activated, the SoC 20 also determines in S14 whether it is an appropriate timing to perform the operation check. The SoC 20 may be configured to output the inaudible sound pattern for the operation check in S15 based on the timing determined in S14, input the inaudible sound pattern from the microphone 41 through the sound input unit 40, and determine in S16 whether the input sound pattern corresponds to the expected pattern. If it is not the timing appropriate for the operation check, the operation check is postponed and the process proceeds to S17.

The “timing at which the operation check can performed” in S14 may be determined based on a condition that the processing load on the vehicle is lower than a predetermined value. For example, the condition may include when the vehicle is stopped immediately after the ignition switch is turned on, or when the vehicle is stopped during manual or autonomous driving. In addition, the timing appropriate for the operation check may be when the vehicle is stopped or parked at the side of the road during the manual driving mode or the autonomous driving mode, where the processing load on the vehicle is relatively low. Contrary, the SoC 20 may make determination of NG in S14 when the processing load is higher than the predetermined value, such as during the autonomous driving or execution of driving assistance using the ADAS function.

The SoC 20 determines in S17 whether a warning is necessary during the vehicle moving after activation. If the SoC 20 determines that a warning is necessary, the SoC 20 outputs the audible sound pattern in S18. The audible sound pattern emitted here is the original sound pattern before being converted into the inaudible pattern for the operation check. This ensures that the audible warning sound pattern can be reliably recognized by the occupants. Thereafter, the SoC 20 repeatedly perform the processes of S14 to S18 while the vehicle is moving after activation until power to the electronic control device 10 is turned off in S19. As a result, it is possible to check whether the speaker 31 and the microphone 41 of the HMI surely function during manual and autonomous drivings.

The operation check has been described as being performed at the time of activation and during the vehicle operating, but the present disclosure is not limited to this. For example, the operation check may be performed only at the time of activation as shown in steps S11 to S13, or only during the vehicle moving as shown in steps S14 to S16.

(Sound pattern details) Hereinafter, sound patterns for the operation check will be described. The sound patterns used when the SoC 20 performs the operation check may be selected according to the constraints of the timing for the operation check and the conditions of the vehicle model. The sound patterns may be preferably selected according to the situation of the vehicle to perform the operation check. For example, the sound pattern used for driving assistance when starting to drive the vehicle may differ from the sound pattern used for driving assistance to have the driver look behind the vehicle when parking the vehicle. Since the volume and pitch of these sound patterns are different, the sound patterns are preferably checked immediately before the sound patterns are actually used.

Also, for example, the sound patterns may have different volumes and frequencies depending on warning stages for the driver. The sound pattern for the operation check may be a separated sound pattern of the sound patterns, or a combined sound pattern composed of more than one of the sound patterns. The warning stages range from minor warnings of low importance to severe warnings of high importance. For example, the sound pattern for a more important warning has greater volume and higher frequency, so that the occupants can easily notice the notifications and warnings.

Also, for example, the sound patterns may have different volumes and frequencies depending on vehicle models. The sound patterns may be different between mass-market vehicles and luxury vehicles. Further, the sound patterns may be different between regular vehicles and emergency vehicles. At this time, it is preferable to use a sound pattern having a volume and frequency characteristic according to the vehicle models.

In addition, when the memory 20a stores multiple sound patterns for the vehicle models, the SoC 20 may select a sound pattern that matches the vehicle model information of own vehicle among the multiple sound patterns stored in the memory 20a to perform the operation check. Furthermore, when the memory 20a stores common sound patterns commonly available for multiple vehicle models, the SoC 20 may select at least one of the common sound patterns to perform the operation check.

The SoC 20 may sequentially check each of the sound patterns each time the operation check is performed. Moreover, the SoC 20 may perform the operation check at once by using a combined sound pattern composed of these sound patterns. By using the combined sound pattern, the warning sounds for the all warning stages and vehicle models can be checked, thereby shortening the checking time.

When the memory 20a separately stores sound patterns for multiple vehicle models, the SoC 20 may selectively read out a sound pattern corresponding to the vehicle model of own vehicle from the memory 20a and output the sound pattern for the operation check.

(Summary of the present embodiment) Repeatedly outputting audible warning sound for operation check may confuse and annoy the occupants. It is preferable to avoid outputting, for even the operation check, noises that are audible to the driver when warning is not needed.

According to this embodiment, the SoC 20 perform the operation check by outputting an inaudible sound pattern that is predetermined based on warning stages for a driver or vehicle models from the speaker 31 through the sound output unit 30, and receiving the inaudible sound pattern from the microphone 41 through the sound input unit 40. During the operation check, a sound pattern that has been converted into an inaudible range to humans is output from the speaker 31, and this sound is input to the microphone 41. Thereby, the SoC 20 checks emission of the sound pattern. Thus, the sound output can be easily checked depending on the type of warnings or notification. In addition, the operation of the sound output unit 30, the speaker 31, the sound input unit 40, and the microphone 41 can be checked, ensuring that a warning is reliably conveyed to the driver in the event of an emergency.

The SoC 20 determines, based on the situations of the driver and the vehicle, the timing of the operation check to be performed during the vehicle operating, and performs the operation check using a sound pattern at the determined timing during the vehicle operating. Thus, the operation check of the sound input/output is performed not only at the time of activation but during the vehicle operating, thereby improving the reliability of the sound input/output.

Since the sound output unit 30 and sound input unit 40 have conventionally been used to operate the HMI function, there is no need to provide a separate sound generation mechanism dedicated to the ADAS function, which reduces the circuit size and costs.

The control device and method described in the present disclosure may be implemented by a special purpose computer which is configured with a memory and a processor programmed to execute one or more particular functions embodied in computer programs of the memory. Alternatively, the control device described in the present disclosure and the method thereof may be realized by a dedicated computer configured as a processor with one or more dedicated hardware logic circuits. Alternatively, the control device and method described in the present disclosure may be realized by one or more dedicated computer, which is configured as a combination of a processor and a memory, which are programmed to perform one or more functions, and a processor which is configured with one or more hardware logic circuits. The computer program may be stored in a computer-readable non-transitory tangible storage medium as an instruction executed by a computer.

Although the present disclosure has been described in accordance with the embodiments, it is understood that the present disclosure is not limited such embodiments or structures described in the embodiments. The present disclosure encompasses various modifications and variations within the scope of equivalents. In addition, various combinations and forms, and further, other combinations and forms including only one element, or more or less than these elements are also within the sprit and the scope of the present disclosure.

1. An electronic control device comprising:
a controller;
a sound output unit electrically connecting the controller to a speaker; and
a sound input unit electrically connecting the controller to a microphone, wherein
the controller is configured to perform an operation check by:
outputting a sound pattern from the speaker through the sound output unit after converting the sound pattern into an inaudible pattern, the sound pattern being at least one of sound patterns predetermined based on warning stages for a driver of a vehicle or vehicle models; and
receiving the sound pattern from the microphone through the sound input unit.

2. The electronic control device according to claim 1, wherein
the sound patterns have different volumes and frequency characteristics according to the warning stages for the driver or the vehicle models, and
the at least one of the sound patterns for the operation check is:
a separated sound pattern of the sound patterns; or
a combined sound pattern composed of more than one of the sound patterns.

3. The electronic control device according to claim 1, wherein
the controller is further configured to sequentially output the sound patterns for the operation check one by one.

4. The electronic control device according to claim 1,
the sound patterns have different volumes and frequency characteristics and are commonly available for the vehicle models, and
the electronic control device further comprising a memory configured to store
a separated sound pattern of the sound patterns, or
a combined sound pattern composed of more than one of the sound patterns, and
the at least one of the sound patterns for the operation check is the separated sound pattern or the combined sound pattern.

5. The electronic control device according to claim 1,
the sound patterns are different among the vehicle models,
the electronic control device further comprising a memory configured to separately store the sound patterns, wherein
the at least one of the sound patterns for the operation check is selected according to a model of the vehicle.

6. The electronic control device according to claim 1, wherein
the controller is configured to:
determine a timing of the operation check to be performed during the vehicle operating based on a situation of the driver or the vehicle, and
perform the operation check using the sound pattern at the determined timing during the vehicle operating.

7. The electronic control device according to claim 1, further comprising
a memory storing the sound pattern, wherein
the controller is configured to compare the sound pattern input from the microphone with the sound pattern stored in the memory for the operation check.

8. The electronic control device according to claim 1, wherein
the sound patterns are different among the vehicle models,
the electronic control device further comprising a memory storing the sound patterns, wherein
the controller is configured to perform the operation check by selecting the at least one of the sound patterns corresponding to a model of the vehicle.
